(19) United States
(12) Patent Application Publication
(10) Pub. No.: US 2020/0048947 A1
(43) Pub. Date: Feb. 13, 2020

(54) ARRANGEMENT FOR GUIDING A SLIDING DOOR OR FOLDING-SLIDING DOOR

(71) Applicant: Julius Blum GmbH, Hoechst (AT)

(72) Inventors: Lukas BLUM, Bregenz (AT); Ingo GASSER, Hoechst (AT); Matthias RUPP, Hohenweiler (AT)

(21) Appl. No.: 16/654,671

(22) Filed: Oct. 16, 2019

Related U.S. Application Data
(63) Continuation of application No. PCT/AT2018/000036, filed on May 4, 2018.

(30) Foreign Application Priority Data
May 11, 2017 (AT) A 50389/2017

(51) Int. Cl. E05D 15/58; E06B 3/50

(52) U.S. Cl. CPC E05D 15/581; E05Y 2201/62; E05Y 2900/212; E06B 3/5045

(57) ABSTRACT

An arrangement for guiding a sliding door or folding-sliding door on a furniture wall, comprising a first guide system to be fastened on the furniture wall and a second guide system to be fastened on the furniture wall at a vertical distance from the first guide system. The two guide systems each have at least one guide and a guide body which is displaceably mounted on the guide, and—a carrier on which the sliding door or folding-sliding door is to be fastened and which is connected in a movement-coupled manner to the two guide bodies of the guide systems. The carrier is assembled in the vertical direction from at least two carrier portions, and the at least two carrier portions can be releasably connected.

### BACKGROUND OF THE INVENTION

The present invention relates to an arrangement for guiding a sliding door or folding-sliding door on a furniture panel and a piece of furniture with at least one such arrangement.

In addition, the invention relates to a method for installing such an arrangement on a furniture panel.

Arrangements for guiding a sliding door or folding-sliding door on a furniture panel which are pre-installed as a complete package on a furniture panel and are also delivered to the customer in this way are already known. This means that, when assembling the furniture, the customer has to secure the heavy and large furniture panel including the arrangement to the piece of furniture.

This has the disadvantage that on the one hand the installation and on the other hand also the transport of such a furniture panel pre-installed with an arrangement are made more difficult. Furniture panels with pre-installed arrangements which have large dimensions protrude, for example, beyond Euro pallets, as a result of which damage can also occur to these furniture panels or these arrangements.

### SUMMARY OF THE INVENTION

The object of the invention is to avoid at least one of the above-described disadvantages and to specify an improved arrangement compared with the state of the art and an improved piece of furniture, whereby installation is preferably made easier.

A further object of the invention is to specify an improved method for installing such an arrangement on a furniture panel.

An essential idea with respect to the arrangement according to the invention is that the support is composed in the vertical direction of at least two support segments, wherein the at least two support segments are releasably connectable. This measure makes it possible to divide the support into smaller support segments, whereby transport is made easier and damage possibly occurring during transport can be prevented.

In order that the release of the connection and also the assembly of the support segments are made easier, it can moreover be provided that the releasable connection of the support segments provided is effected via angled plates, which are preferably connectable to the support segments via a plug-in and/or screw connection.

In the case of a piece of furniture with at least one furniture panel, at least one sliding door or folding-sliding door, and at least one arrangement, wherein the first and second guide systems are fastened to the at least one furniture panel and the at least one sliding door or folding-sliding door is fastened to the support, it can be provided that the piece of furniture has a receiving area for receiving components of a kitchen, a clothes-storage device, or the like. The items just named can thereby be arranged in the piece of furniture, and can be covered by the arrangement and the sliding door or folding-sliding door.

### BRIEF DESCRIPTION OF THE DRAWINGS

Further advantages and details of the invention are revealed by the figures and the associated description of the figures, wherein the method according to the invention is also explained in more detail with reference to the description of the figures. There are shown in:

FIGS. 1a-1c perspective views of a piece of furniture with two folding-sliding doors, wherein the folding-sliding doors are represented in different positions,

FIG. 2 a furniture panel with the two guide systems and the pull cord device in a top view,

FIGS. 3a-3b a furniture panel with two guide systems arranged thereon in a perspective view and a detail representation thereof,

FIGS. 4a-4c a furniture panel with two guide systems arranged thereon in a perspective view and two detail representations thereof,

FIGS. 5a-5c detail representations of the synchronization device,

FIGS. 6a-6b the support and the releasable connection between two support segments in a perspective view,

FIGS. 7a-7b the furniture panel with two guide systems arranged thereon in a perspective view and a detail representation thereof,

FIGS. 8a-8b the furniture panel with two guide systems arranged thereon in a perspective view and a detail representation thereof,

FIGS. 9a-9c the furniture panel with two guide systems arranged thereon and two support segments connected to each other in a perspective view and two detail representations of the releasable connection via angled plates,

FIG. 10 the furniture panel with a further embodiment example of the support in a perspective view,

FIGS. 11a-11c the furniture panel and the further embodiment example of the support in perspective views, and

FIG. 12 the furniture panel with arrangement and assembled support.

### DETAILED DESCRIPTION OF THE INVENTION

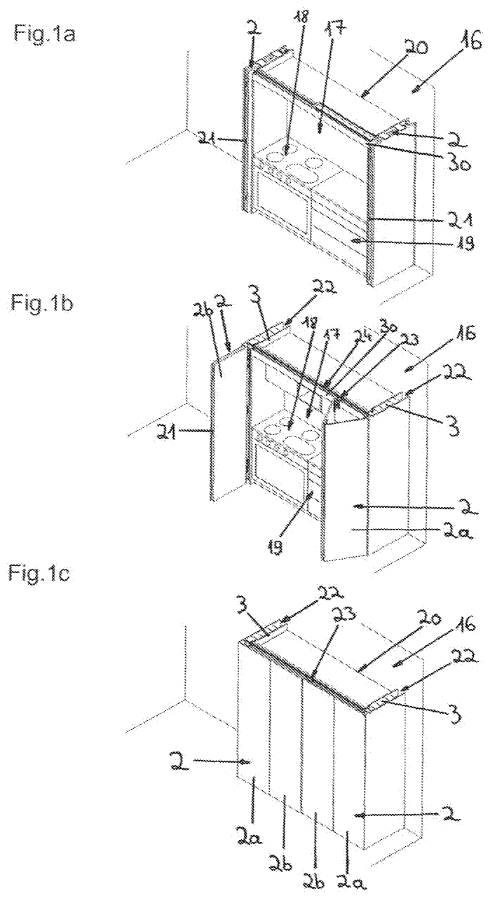

FIGS. 1a, 1b and 1c show a piece of furniture 16, with a fixed part 20, two furniture panels 3 and two folding-sliding doors 2. These two folding-sliding doors 2 each have a first door leaf 2a and a second door leaf 2b, wherein the two door leaves 2a, 2b can be folded via the folding door hinge 21. The piece of furniture 16 furthermore has a receiving area 17 and two laterally arranged receiving slots 22 or “pockets”. It is thus provided that the piece of furniture 16 has a receiving area 17 for receiving components of a kitchen 18 (for example electrical devices such as hob, oven, etc.), a clothes-storage device 19 (for example drawers, clothes hangers, boxes, etc.) or the like.

In addition, it is provided that the piece of furniture 16 has at least one receiving slot 22, which is preferably arranged laterally in or on the piece of furniture 16 and into which the at least one folding-sliding door 2 is retractable. Thus either the receiving slot 22 can be arranged on the piece of furniture 16 from the outside or else the receiving slot 22 is formed in the piece of furniture 16, for example by the arrangement of an additional panel. In the receiving slots 22 or, more precisely, on the furniture panels 3 the arrangements 1 (not visible) are arranged for guiding the folding-sliding doors 2, with the result that the folding-sliding doors 2 are retractable into these receiving slots 22. The two receiving slots 22 have a clear width of from 10 to 30 cm and/or a height of from 100 to 250 cm and/or a depth of from 60 to 100 cm.

The representation shown in FIG. 1a corresponds to the parked position of the folding-sliding doors 2 and that in FIG. 1c corresponds to the closed position of the folding-sliding doors 2. The second door leaf 2b is in each case coupled to a slide mechanism 23, wherein the slide mechanism 23 is displaceable along a slide mechanism rail 24. This slide mechanism rail 24 is arranged substantially transverse to the guide systems 4a, 4b (not visible) on the piece of furniture 16. In addition, a bar 30 is provided which either is part of the slide mechanism rail 24 or is designed as a component separate therefrom. The movement of the folding-sliding doors 2 between the parked position and the closed position is thus made possible by the guide systems 4a, 4b and the slide mechanism rail 24. Starting from the parked position of the folding-sliding doors 2, in which the door leaves 2a, 2b are aligned substantially parallel to each other, the folding-sliding doors 2 can thus be moved into the position in FIG. 1b, which can be seen with reference to the folding-sliding doors 2 represented on the left. In the process, the folding-sliding doors 2 are displaced along the guides 5a, 5b (not visible) of the guide systems 4a, 4b. Subsequently, the folding-sliding doors 2 are brought into the substantially coplanar position according to FIG. 1c. For this, in each case the door leaf 2b is displaced with the aid of the slide mechanism 23 along the slide mechanism rail 24, until the closed position of the folding-sliding doors 2 is reached, in which the two door leaves 2a, 2b are aligned substantially coplanar. The same process is passed through in reverse order to move the folding-sliding doors 2 from their closed position into their parked position.

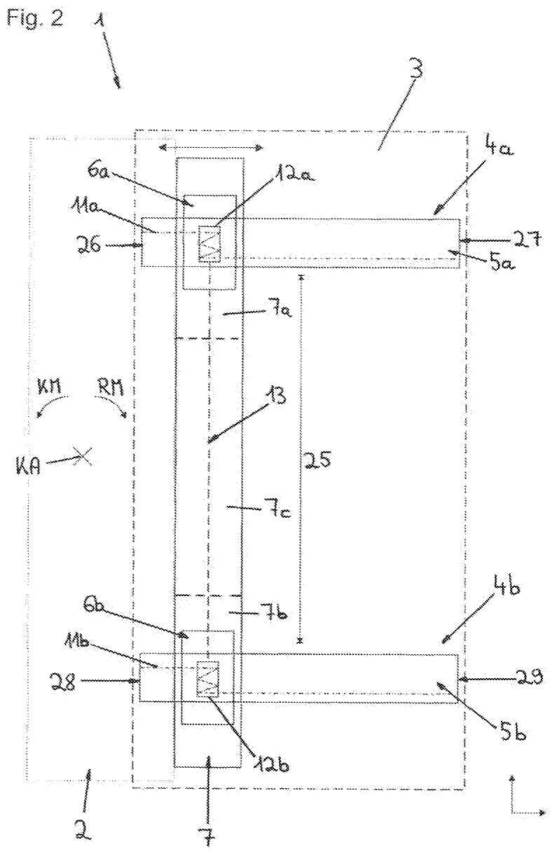

FIG. 2 shows an embodiment example of the arrangement 1 for guiding a sliding door or folding-sliding door 2 on a furniture panel 3. This arrangement 1 can thus be used to move a folding-sliding door 2 along the furniture panel 3 into or out of the receiving slots 22, which are provided in the case of a piece of furniture 16 according to FIGS. 1a to 1c. A first guide system 4a to be fastened to the furniture panel 3 and a second guide system 4b to be fastened to the furniture panel 3 at a vertical distance 25 from the first guide system 4a are provided, wherein the two guide systems 4a, 4b each have a guide 5a, 5b and a guide body 6a, 6b displaceably mounted on the guide 5a, 5b. Furthermore, the arrangement 1 comprises a support 7, to which the sliding door or folding-sliding door 2—indicated by a dotted line—is to be fastened and which is connected in a movement-coupled manner to the two guide bodies 6a, 6b of the guide systems 4a, 4b. The division of the support 7 into the three support segments 7a, 7b, 7c is also indicated by dashed lines. It is thus provided that the support 7 is composed in the vertical direction of at least three support segments 7a, 7b, 7c, wherein a first support segment 7a is connected to the guide body 6a of the first guide system 4a and a second support segment 7b is connected to the guide body 6b of the second guide system 4b, and wherein a third support segment 7c connects the first and second support segments 7a, 7b to each other.

Furthermore, the arrangement 1 has a pull cord device to compensate for a tilting moment KM of the support 7 or of a sliding door or folding-sliding door 2 arranged thereon about a tilt axis KA through a righting moment RM. In the case of a vertical alignment of the support 7 or of the sliding door or folding-sliding door 2 the tilt axis KA is aligned horizontally. The pull cord device thus ensures that the sliding door or folding-sliding door 2 is guided stably in every position, without a tilting or, in the case of a guiding on two guide systems 4a, 4b aligned substantially parallel, a canting resulting.

In addition, it is provided that the pull cord device comprises two pull cords 11a, 11 b separated from each other, wherein the pull cord 11a is arranged between the guide body 6a of the first guide system 4a and both ends 26, 27 of the guide 5a of the first guide system 4a and is formed without connection to the second guide system 4b, and that the pull cord 11b is arranged between the guide body 6b of the second guide system 4b and both ends 28, 29 of the guide 5b of the second guide system 4b and is formed without connection to the first guide system 4a. In this embodiment example, although a synchronization device 13 is drawn in between the gripping means 12a, 12b, it can also be omitted. This thus means that the pull cords 11a and 11b are not connected firmly to the gripping means 12a and 12b with their ends, but only rest against the gripping means 12a, 12b in a frictionally engaged manner with at least one, preferably several, windings. It can thus also be provided that each of the guide bodies 6a, 6b comprises at least one gripping means 12a, 12b for at least one pull cord 11a, 11b, and the gripping means 12a, 12b of the guide bodies 6a, 6b can be coupled via at least one synchronization device 13 separated from the support 7, preferably wherein the at least one synchronization device 13 is formed to transmit a torque between the gripping means 12a, 12b of the guide bodies 6a, 6b.

The ends of the pull cords 11a and 11 b are in each case fastened to the ends 26 and 27 or 28 and 29 of the guides 5a and 5b. During a movement of the support 7 along the guide systems 4a and 4b the pull cords 11a and 11b are unwound by a particular amount and at the same time wound again by the same amount, with the result that the number of windings remains substantially unchanged. Through the winding and unwinding of the pull cords 11a, 11 b during a displacement of the support 7 along the guides 5a, 5b the gripping means 12a, 12b are set in rotation about an axis of rotation. This axis of rotation can be effected, depending on the mounting of the gripping means 12a, 12b on the guide bodies 6a, 6b, either about a vertical axis or about a horizontal axis. The gripping means 12a, 12b here need not necessarily be storage and winding devices. The only essential thing is that the pull cords 11a, 11 b are held tightly between the ends 26, 27, 28, 29 of the guides 5a, 5b and the guide bodies 6a, 6b in every position of the guide bodies 6a, 6b relative to the guides 5a, 5b. In this way, the pull cords 11a, 11 b can exert a force between the ends 26, 27, 28, 29 and the guide bodies 6a, 6b and thus provide a righting moment RM to compensate for the tilting moment KM.

It is pointed out that the embodiment example of the pull cord device according to FIG. 2 is to be understood only by way of example. Alternative embodiment examples can be found in the application under the file number A 50019/2017.

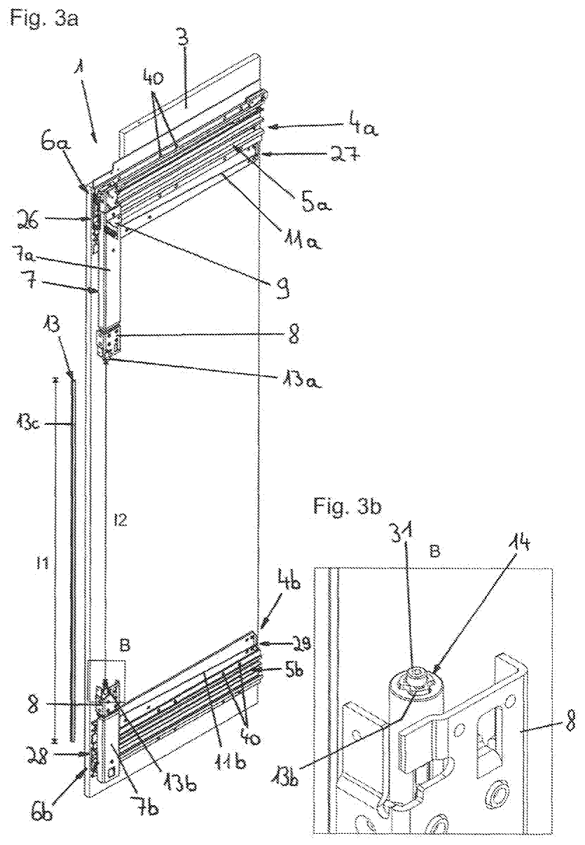

FIG. 3a shows the furniture panel 3 and the arrangement 1 according to FIG. 2 in a perspective view. The support segments 7a, 7b each have an angled plate 8, which serves to connect the respective support segments 7a, 7b, 7c to each other. An interface 9, which serves to fasten the folding-sliding door 2, is represented here. In this connection, it is pointed out that in the case of the arrangement 1 it can be provided that the support 7 has at least two, preferably three, interfaces 9 for fastening the sliding door or folding-sliding door 2, wherein the at least two interfaces 9 are arranged on different support segments 7a, 7b, 7c of the support 7, preferably wherein at least one interface 9 is adjustable in the vertical direction. Furthermore, the synchronization device 13 is shown, which is composed in the vertical direction of three synchronization segments 13a, 13b, 13c, wherein the three synchronization segments 13a, 13b, 13c are releasably connectable. The length l1 of the synchronization segment 13c is between 5 and 20 mm, preferably 10 mm, smaller than the clear width l2 between the two synchronization segments 13a and 13b. Moreover, the passage openings 40, which serve to fasten the two guide systems 4a, 4b on the furniture panel 3, can be seen. The fastening can be effected for example via screws. It can moreover be provided that at least one of the synchronization segments 13a, 13b, 13c, preferably the third synchronization segment 13c, is adjustable in its length. It is thereby ensured that the synchronization device 13 can be used for folding-sliding doors 2 with different heights. FIG. 3b shows a detail representation of the area B according to FIG. 3a. The synchronization segment 13b can be seen here. A sleeve 14 is mounted displaceably on the circumference of the synchronization segment 13b, wherein a spacer screw 31 is additionally arranged at the upper end of the synchronization segment 13b.

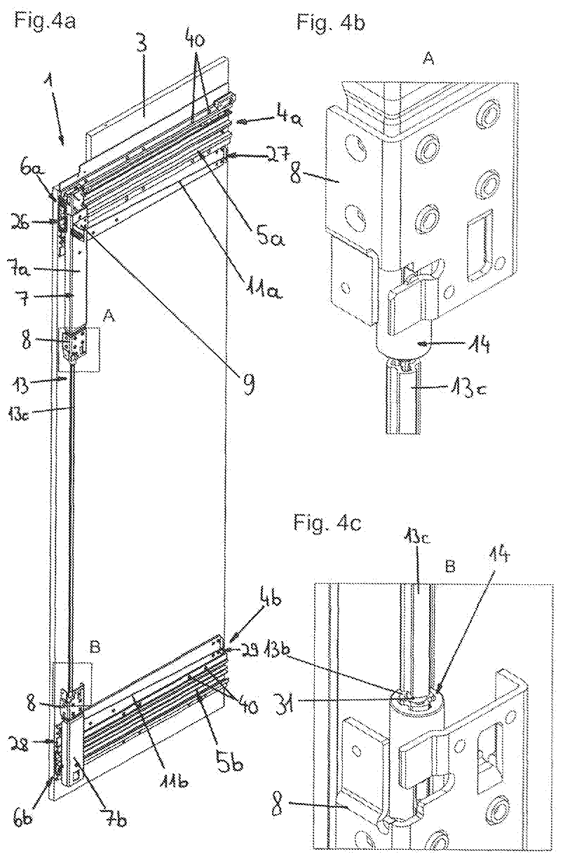

FIG. 4a shows the furniture panel 3 and the arrangement according to FIG. 3a, wherein the synchronization segment 13c has already been fitted on the spacer screw 31. For this, the synchronization segment 13c has thus been displaced in the horizontal direction and positioned on the spacer screw 31. FIG. 4b and FIG. 4c show a detail representation of the area A or of the area B according to FIG. 4a. It can be seen here that an interspace 32 is formed in each case between the synchronization segments 13a and 13c or 13b and 13c, wherein the synchronization segment 13c is height-adjusted by the spacer screw 31. The inner contour of the sleeve 14 is based on the outer contour of the synchronization segments 13a, 13b, 13c, with the result that the sleeve 14 is displaceable along these synchronization segments 13a, 13b, 13c. It is pointed out that the installation of the synchronization device 13 or the connection of the synchronization segments 13a, 13b, 13c can be carried out from the front of the piece of furniture 16. Only the guide bodies 6a, 6b and thus also the support 7 need to be moved into the position shown according to FIG. 4a.

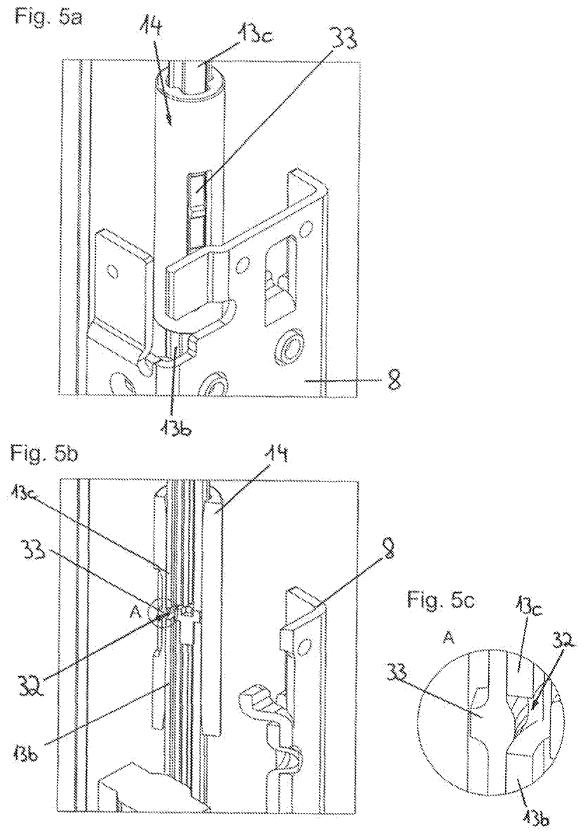

FIGS. 5a to 5c show the releasable connection between the synchronization segments 13b and 13c. It is pointed out that the releasable connection between the synchronization segments 13a and 13c is effected analogously thereto. The sleeve 14 is thus displaced in the direction of the synchronization segment 13c, until the frictionally engaged spring 33 of the sleeve 14 reaches the interspace 32 and snaps into place in it. It is thus provided that the releasable connection of the synchronization segments 13a, 13b, 13c is effected via sleeves 14 displaceable in the vertical direction.

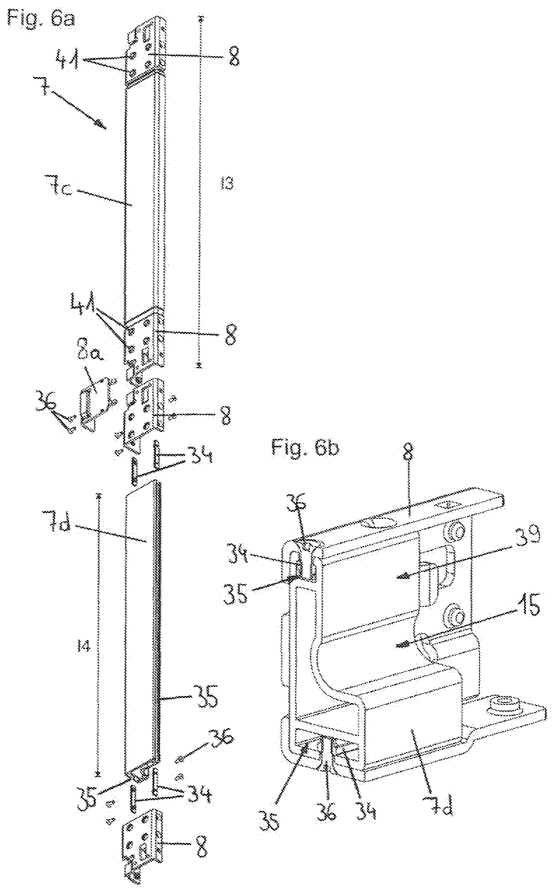

FIG. 6a shows the two support segments 7c, 7d of the support 7. It is thus provided that the third support segment 7c has a fixed length l3 and optionally a fourth support segment 7d, which is adjustable in its length l4, is provided. Thus, the support 7 can be adjusted to different heights of a folding-sliding door 2. The upper angled plate 8 of the support segment 7c in the representation in this case serves to connect to the support segment 7a, wherein it is provided that this support segment 7c and the two angled plates 8 connected to it are pre-installed. The angled plates 8 are riveted to the support segment 7c via the rivets 41. The length l3 of the support segment 7c is chosen corresponding to the smallest height of a folding-sliding door 2, with the result that the support segment 7d is not necessary in the case of a folding-sliding door 2 with this height. If, however, taller folding-sliding doors 2 are provided, then the support segment 7d can be accordingly adjusted in its length l4 and connected to the support segment 7c. The lower angled plate 8 of the support segment 7c serves to connect to the upper angled plate 8 of the support segment 7d. In this case a further angled plate 8a is provided, which connects these two angled plates 8 to each other. To connect the respective angled plates 8 to the support segment 7d, slot nuts 34 are provided in each case, which are displaceable in the grooves 35 of the support segment 7d. The length l4 of the support segment 7d can thereby be adjusted, wherein it is furthermore guaranteed that the angled plates 8 are fastenable to the support segment 7d.

FIG. 6b shows a sectional representation with respect to the connection between angled plate 8 and support segment 7d. The slot nuts 34 are inserted into the grooves 35 of the support segment 7d provided for them. The angled plates 8 are then fitted on the support segment 7d, with the result that the respective holes for connecting the angled plates 8 to the support segment 7d are arranged one over another. After that, the countersunk screws 36 can be screwed into these holes, with the result that a releasable plug-in and screw connection between the support segment 7d and the angled plates 8 is achieved. It is furthermore provided that the support 7 or the support segments 7a, 7b, 7c, 7d are formed substantially L-shaped in cross section, and/or have at least one recess 15 for receiving at least one optionally provided synchronization device 13. Because of the substantially L-shaped formation of the support segment 7d, a flattened spot 39 thus results, with the result that the installation of the support segment 7d is made easier.

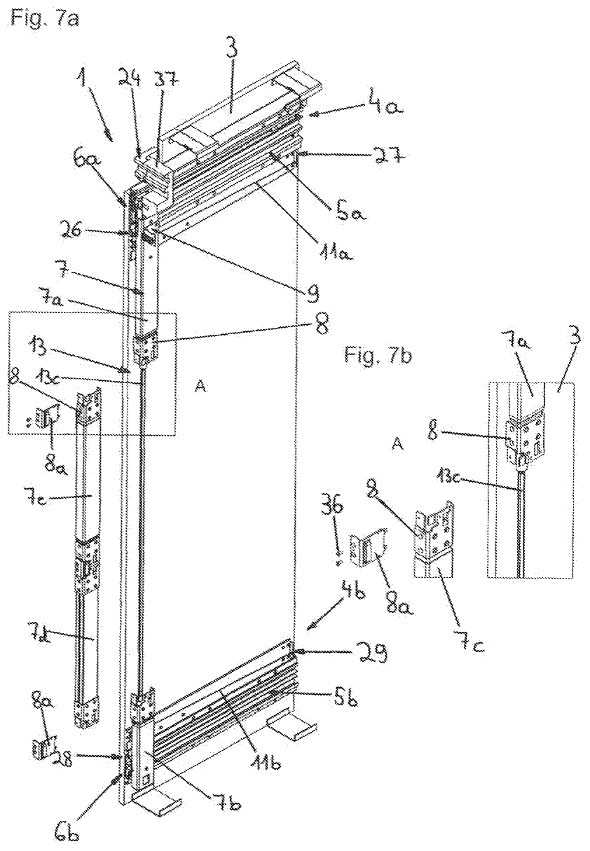

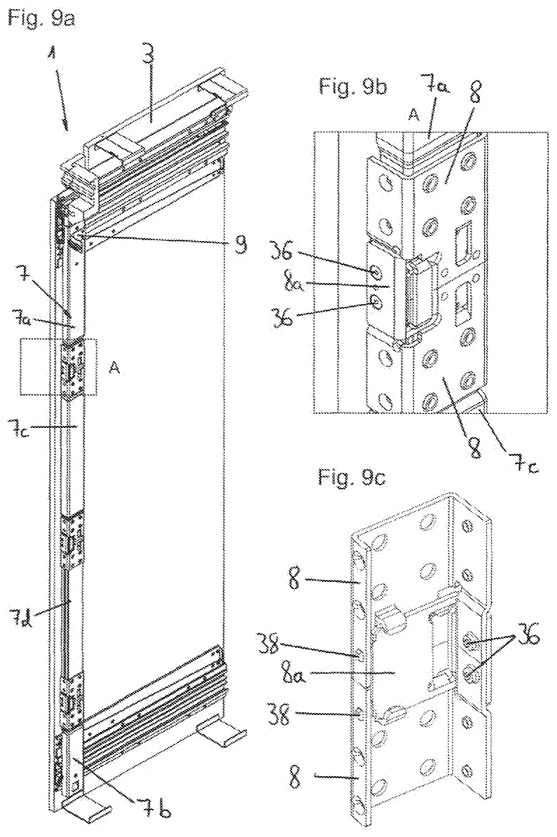

FIG. 7a shows the furniture panel 3 and the arrangement 1. A part of the slide mechanism rail 24 can be seen here, wherein a connecting piece 37 for the slide mechanism rail 24 is additionally arranged on the support segment 7a. The connecting piece 37 is formed as a support. In order to make it possible to displace the folding-sliding door 2 along the guides 5a, 5b of the guide systems 4a, 4b, the slide mechanism 23 is displaced onto this connecting piece 37, with the result that the door leaves 2a, 2b are aligned substantially parallel to each other. In this case, the two support segments 7c, 7d have already been connected to each other and can be connected to the two support segments 7a, 7b as a pre-installed support 7. Starting from FIG. 6a, to connect the two partial segments 7c, 7d, the lower angled plate 8 of the support segment 7c and the upper angled plate 8 of the support segment 7d are moved towards each other until they rest against each other. The angled plate 8a according to the representation of FIG. 6a is then pushed towards the right into the angled plates 8 and releasably fixed to each other via a plug-in and screw connection. This type of connection can be seen more precisely with reference to FIG. 9c. To connect the two support segments 7c, 7d connected to each other to the support segments 7a, 7b, the support segments 7c, 7d are then shifted via the synchronization device 13, with the result that the respective angled plates 8 rest against each other. This is possible because of the L-shaped formation and the flattened spot 39 of the support segments 7c, 7d. The synchronization device 13 is thus received in the recess 15.

FIG. 7b shows a detail representation of the area A of FIG. 7a. At this point it is pointed out that the installation of the support 7 can also be carried out from the front of the piece of furniture 16, if the guide bodies 6a, 6b are moved into the position according to FIG. 7a.

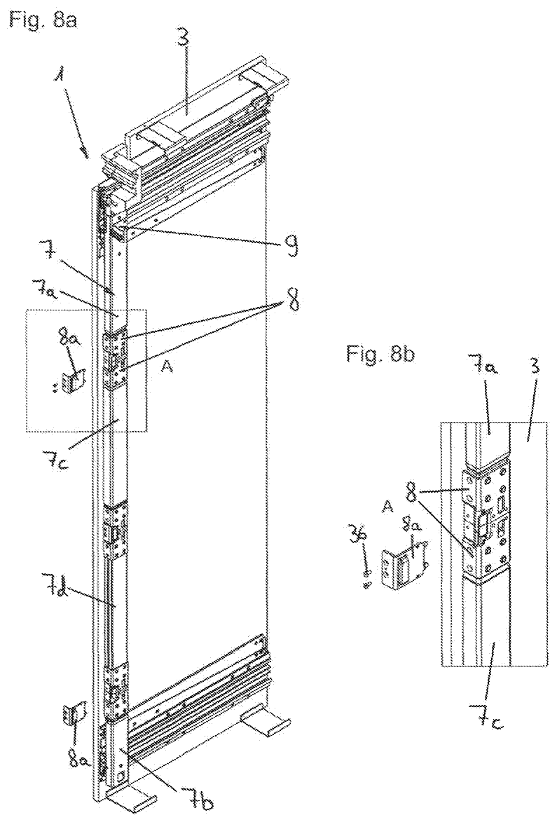

FIG. 8a shows the support segments 7c, 7d in their position for installation with the support segments 7a, 7b. This can also be seen with reference to FIG. 8b, which shows a detailed view of the area A of FIG. 8a. To connect the respective support segments 7a, 7b, 7c, 7d, the angled plates 8a are thus pushed into the angled plates 8, with the result that the support segments 7a, 7b, 7c, 7d or the angled plates 8 are releasably connected to each other via a plug-in connection. The countersunk screws 36 are then screwed into the holes provided for them, with the result that a screw connection is also effected.

FIGS. 9a to 9c show the support segments 7a, 7b, 7c, 7d releasably connected to each other. FIG. 9b shows a more precise representation of the area A of FIG. 9a and FIG. 9c shows a more precise view of the plug-in and screw connection between the angled plates 8, 8a. To connect the angled plates 8 to each other, it is provided that the angled plate 8a is pushed into the angled plates 8 until the plug-in connectors 38 engage in the corresponding openings of the angled plates 8. After that the countersunk screws 36 are screwed into the respective holes of the angled plates 8, with the result that a plug-in and screw connection results.

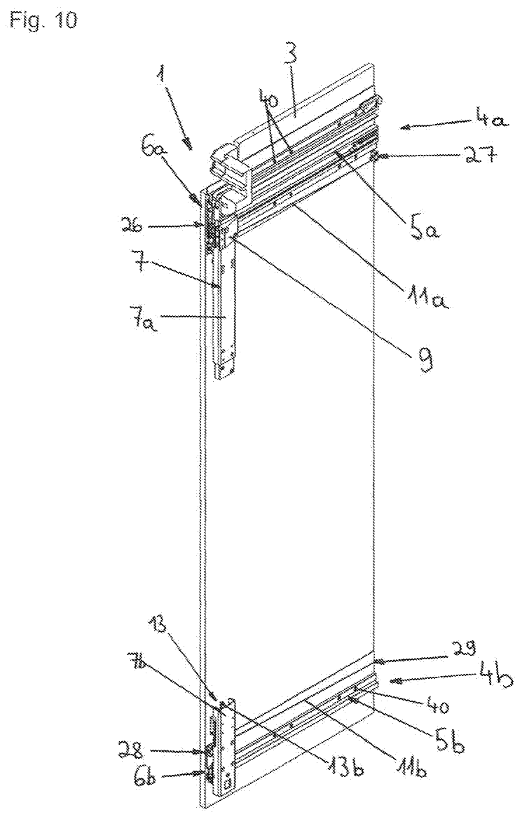

FIG. 10 shows the furniture panel 3 and the arrangement 1, wherein the support 7 is formed according to an alternative embodiment. In this case the support 7 has a first support segment 7a and a second support segment 7b. The first support segment 7a is connected in a movement-coupled manner to the guide body 6a of the first guide system 4a and the second support segment 7b is connected in a movement-coupled manner to the guide body 6b of the second guide system 4b. An interface 9 for fastening the folding-sliding door 2 is arranged in each case on the support segment 7a and on the support segment 7b.

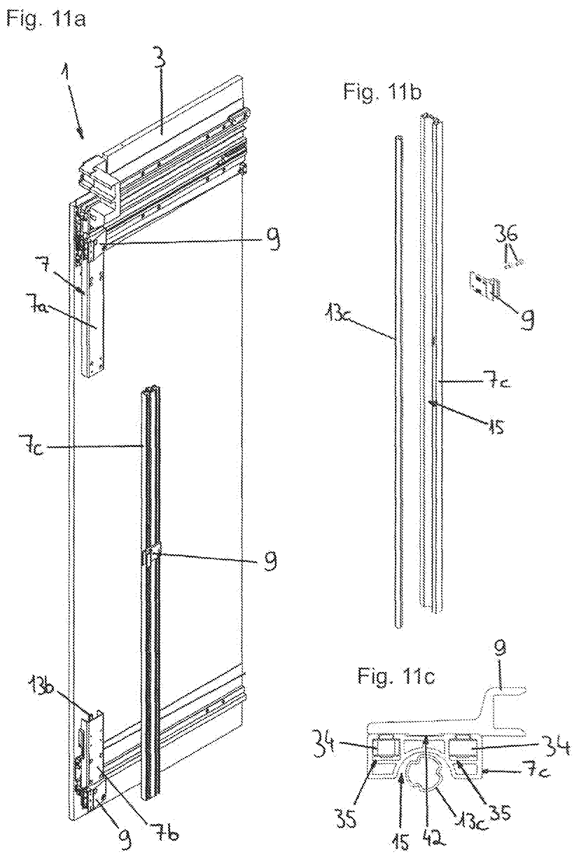

In comparison with FIG. 10, FIG. 11a additionally shows the third support segment 7c, which serves to connect the first 7a and the second 7b support segments to each other.

FIG. 11b shows the third support segment 7c in a perspective view and FIG. 11c shows the third support segment 7c with the interface 9 in a sectional perspective. The support segment 7c has a recess 15 for receiving the third synchronization segment 13c. The interface 9 represented is fastenable to the support segment 7c at different vertical positions with the aid of countersunk screws 36. This is achieved by the slot nuts 34 displaceable in the grooves 35. The slot nuts 34 are thus pushed into the desired position and then the countersunk screws 36 are screwed into the slot nuts 34 through the interface 9, with the result that the interface 9 is fixed in the desired position. With reference to FIG. 11c it can in addition be seen that on the side facing the support segment 7c the interface 9 has a friction surface 42, which cooperates with the support segment 7c. An improved fastening of the interface 9 to the support segment 7c thereby results.

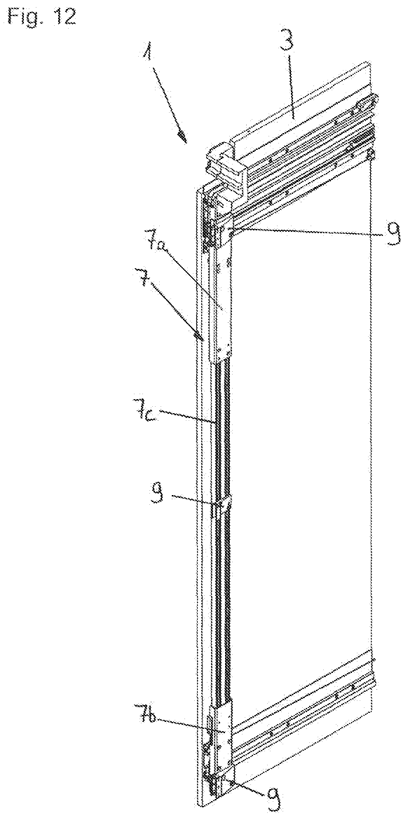

FIG. 12 shows the assembled support 7, wherein the support segment 7c connects the first support segment 7a and the second support segment 7b to each other.

In the case of an arrangement 1 according to the invention, it can thus be provided that all pre-installed components of the arrangement 1 have a maximum length of 1200 mm and a maximum width of 800 mm, with the result that they can be arranged on a Euro pallet for shipping purposes. The pre-installed components include in this respect for example:
the first guide system 4a and the first support segment 7a connected to the guide body 6a of the first guide system 4a,
the second guide system 4b and the second support segment 7b connected to the guide body 6b of the second guide system 4b, and
the support segment 7c pre-installed with the angled plates 8 via rivets 41 according to FIG. 6a.

The method according to the invention for installing the arrangement 1 on the furniture panel 3 is explained with reference to FIGS. 2 to 9c, wherein:
in a first method step the first guide system 4a or the second guide system 4b is fastened to the furniture panel 3,
in a second method step the other guide system 4a, 4b is fastened to the furniture panel at a vertical distance 25 from the guide system 4a, 4b fastened to the furniture panel 3 during the first method step, and
in a third method step the guide bodies 6a, 6b of the guide systems 4a, 4b are connected to each other in a movement-coupled manner via the support 7, wherein the at least two support segments 7a, 7b, 7c, 7d of the support 7 are releasably connected.

It can be provided that the arrangement 1 has at least one synchronization device 13, and in a further method step, which is carried out before or after the third method step, the at least one synchronization device 13 is arranged between the guide bodies 6a, 6b of the guide systems 4a, 4b, wherein the at least two synchronization segments 13a, 13b, 13c are releasably connected. It is preferably provided that the support 7 and the at least one optionally provided synchronization device 13 are moved in the horizontal direction for the installation.

### LIST OF REFERENCE NUMBERS

1 arrangement
2 folding-sliding door
2a first door leaf
2b second door leaf
3 furniture panel
4a first guide system
4b second guide system
5a guide of the first guide system
5b guide of the second guide system
6a guide body of the first guide system
6b guide body of the second guide system
7 support
7a first support segment
7b second support segment
7c third support segment
7d fourth support segment
8 angled plate
8a angled plate
9 interfaces
11a pull cord
11b pull cord
12a gripping means
12b gripping means
13 synchronization device
13a first synchronization segment
13b second synchronization segment
13c third synchronization segment
14 sleeves
15 recess
16 piece of furniture
17 receiving area
18 components of a kitchen
19 clothes-storage device
20 fixed part of the piece of furniture
21 folding door hinge
22 receiving slot
23 slide mechanism
24 slide mechanism rail
25 vertical distance
26,27 ends of the guide of the first guide system
28,29 ends of the guide of the second guide system
30 bar
31 spacer screw
32 interspace
33 frictionally engaged spring
34 slot nut
35 groove
36 countersunk screws
37 connecting piece
38 plug-in connector
39 flattened spot
40 passage openings
41 rivets
42 friction surface
KA tilt axis
KM tilting moment
RM righting moment
l1 length of the third synchronization segment
l2 clear width between the first and second synchronization segments
l3 length of the third support segment
l4 length of the fourth support segment

1. An arrangement for guiding a sliding door or folding-sliding door on a furniture panel, with
a first guide system to be fastened to the furniture panel and a second guide system to be fastened to the furniture panel at a vertical distance from the first guide system, wherein the two guide systems each have at least one guide and a guide body displaceably mounted on the guide, and
a support, to which the sliding door or folding-sliding door is to be fastened and which is connected in a movement-coupled manner to the two guide bodies of the guide systems,
wherein the support is composed in the vertical direction of at least two support segments, wherein the at least two support segments are releasably connectable.

2. The arrangement according to claim 1, wherein the releasable connection of the support segments provided is effected via angled plates, which are preferably connectable to the support segments via a plug-in and/or screw connection.

3. The arrangement according to claim 1, wherein the support is composed in the vertical direction of at least three support segments, wherein a first support segment is connected to the guide body of the first guide system and a second support segment is connected to the guide body of the second guide system, and wherein a third support segment connects the first and second support segments to each other.

4. The arrangement according to claim 3, wherein the third support segment has a fixed length and optionally a fourth support segment, which is adjustable in its length, is provided.

5. The arrangement according to claim 1, wherein all pre-installed components of the arrangement have a maximum length of 1200 mm and a maximum width of 800 mm, with the result that they can be arranged on a Euro pallet for shipping purposes.

6. The arrangement according to claim 1, wherein the support has at least two, preferably three, interfaces for fastening the sliding door or folding-sliding door, wherein the at least two interfaces are arranged on different support segments of the support, preferably wherein at least one interface is adjustable in the vertical direction.

7. The arrangement according to claim 1, wherein the arrangement has a pull cord device to compensate for a tilting moment of the support or of the sliding door or folding-sliding door arranged thereon about a tilt axis through a righting moment, preferably wherein the pull cord device comprises at least two pull cords separated from each other, a first of these two pull cords is arranged between the guide body of the first guide system and at least one end of the guide of the first guide system and is formed without connection to the second guide system, and a second of these two pull cords is arranged between the guide body of the second guide system and at least one end of the guide of the second guide system and is formed without connection to the first guide system.

8. The arrangement according to claim 7, wherein each of the guide bodies comprises at least one gripping means for at least one pull cord, and the gripping means of the guide bodies can be coupled via at least one synchronization device separated from the support, preferably wherein the at least one synchronization device is formed to transmit a torque between the gripping means of the guide bodies.

9. The arrangement according to claim 8, wherein the at least one synchronization device is composed in the vertical direction of at least two synchronization segments, wherein the at least two synchronization segments are releasably connectable, preferably wherein the releasable connection of the synchronization segments is effected via sleeves displaceable in the vertical direction.

10. The arrangement according to claim 9, wherein at least one of the synchronization segments is adaptable in its length.

11. The arrangement according to claim 1, wherein the support or the support segments are formed substantially L-shaped in cross section, and/or have at least one recess for receiving at least one optionally provided synchronization device.

12. A piece of furniture with at least one furniture panel, at least one sliding door or folding-sliding door, and the arrangement according to claim 1, wherein the first and second guide systems are fastened to the at least one furniture panel and the at least one sliding door or folding-sliding door is secured to the support.

13. The piece of furniture according to claim 12, wherein the piece of furniture has a receiving area for receiving components of a kitchen, a clothes-storage device, or the like.

14. A method for installing the arrangement according to claim 1 on a furniture panel, wherein
in a first method step the first guide system or the second guide system is fastened to the furniture panel,
in a second method step the other guide system is fastened to the furniture panel at a vertical distance from the guide system fastened to the furniture panel during the first method step, and
in a third method step the guide bodies of the guide systems are connected to each other in a movement-coupled manner via the support, wherein the at least two support segments of the support are releasably connected.

15. The method according to claim 14, wherein the arrangement has at least one synchronization device, and the method further comprising, before or after the third method step, the at least one synchronization device is arranged between the guide bodies of the guide systems, wherein at least two synchronization segments of the synchronization device are releasably connected.

16. The method according to claim 14, wherein the support and at least one optionally provided synchronization device are moved in the horizontal direction for the installation.
